(19) United States
(12) Patent Application Publication
(10) Pub. No.: US 2013/0269813 A1
(43) Pub. Date: Oct. 17, 2013

(54) Valve Combined With Water Hammer Arrester

(71) Applicants: Mi Soon Park, (US); ASIA UNION CO., LTD., Pocheon-si Gyeonggi-do (KR)

(72) Inventor: Jae Ik Jang, Seoul (KR)

(73) Assignees: Asia Union Co., Ltd., Pocheon-si Gyeonggi-do (KR); Mi Soon Park, Seoul (KR)

(21) Appl. No.: 13/682,523

(22) Filed: Nov. 20, 2012

(30) Foreign Application Priority Data
Apr. 14, 2012 (KR) 10-2012-0038842
Sep. 3, 2012 (KR) 10-2012-0097221

(51) Int. Cl. F16L 55/055

(52) U.S. Cl. CPC F16L 55/055
USPC 138/30

(57) ABSTRACT

The present invention relates to a valve combined with a water hammer arrester, including the water hammer arrester having a cylindrical casing having one side closed and the other side open, a shock-absorbing material being put into the cylindrical casing, and a piston adapted to be inserted into the cylindrical casing, the piston having packing members mounted thereon to prevent the leakage of the shock-absorbing material, wherein a drive part of the valve has an insertion portion formed by reducing the lower portion of the water hammer arrester, so that the insertion portion of the water hammer arrester functions as a spindle of the valve and a body of the water hammer arrester functions as an operating handle of the valve.

### CROSS-REFERENCE TO RELATED APPLICATIONS

This application is based on and claims priority from Korean Patent Applications Nos. 10-2012-0038842 and 10-2012-0097221, filed Apr. 14, 2012 and Sep. 3, 2012 in the Korean Intellectual Property Office, the disclosures of which are incorporated herein by reference.

### BACKGROUND OF THE INVENTION

1. Field of the Invention

The present invention relates to a valve combined with a water hammer arrester, and more particularly, to a valve combined with a water hammer arrester wherein the valve connected horizontally on a pipe is coupled integrally to the water hammer arrester, unlike the conventional practice wherein the valve and the water hammer arrester are installed separably from each other.

2. Description of Related Art

Generally, if the flow of a fluid like water on a pipe instantaneously stops, strong shock and noise occur in the pipe due to the inertia of the fluid to cause serious pipe damage. So as to absorb such water hammer, a water hammer arrester is located at the position near the valve. The valve has a ball valve structure wherein the valve is horizontally connected to a pipe through which water is supplied from an external water supply source and an angle valve structure wherein a passage of 45 or 90 degrees is formed.

The valve largely includes an inlet connection port connected horizontally to a branch pipe of a pipe from which water is supplied to a tub, a discharge connection port connected vertically to the tub by means of a connection pipe, a shutoff part for opening/closing a passage, and a drive part having a handle and a spindle for driving the shutoff part. On the other hand, a water hammer arrester is formed by putting a shock-absorbing material into a cylindrical casing and inserting a piston into the cylindrical casing, while having packing members adapted to prevent the shock-absorbing material from leaking. Next, the lower portion of a body of the water hammer arrester is reduced in diameter to form an insertion portion, and the insertion portion is inserted into a socket connection member for the installation on a given connection port. After that, the insertion portion is welded integrally to the socket connection member in such a manner as to be coupled to the given connection port. Especially, in case of an angle valve generally used, as shown in FIG. 1, it is made with a separately formed connection port for a water hammer arrester, and alternatively, a separate “T”-shaped connection member may be used to correspond to the socket connection member of the water hammer arrester.

Accordingly, the conventional structure wherein the valve is coupled to the water hammer arrester by using the angle valve or the specific connection member accompanies some problems. First, the whole volume of the valve becomes increased because of the installation of the additional connection member, and second, the additional machining area becomes expanded. Third, the separate parts should be purchased, and Last, the lower end of the water hammer arrester coupled to the connection member should be welded to the connection member.

Generally, a ball valve is installed on a horizontal connection pipe through which water is supplied to a tub or a washing machine, and so as to absorb the water hammer generated at the time when the passage to the ball valve is closed, an intermediate connection member in the shapes of T, elbow, and cross is disposed between the ball valve and the connection pipe. Thus, the water hammer arrester is mounted on the branch pipe of the intermediate connection member. On the other hand, the water hammer arrester has the insertion portion formed by reducing the lower portion of the body thereof, and the insertion portion is inserted into the socket connection member and welded thereto, thereby completing the formation of the water hammer arrester. Next, the socket connection portion welded to the water hammer arrester is coupled to the branch pipe of the intermediate connection member.

Therefore, the conventional coupling structure is formed by connecting the valve, the water hammer arrester, the intermediate connection member, and the connection pipe arranged independently of one another. As a result, the number of parts constituting the valve structure becomes increased, and the number of step by step processes for connecting the parts becomes increased. So as to connect the water hammer arrester to the branch pipe of the intermediate connection member, further, the socket connection member should be welded to the insertion portion of the water hammer arrester, which raises additional manufacturing costs.

### BRIEF SUMMARY OF THE INVENTION

Accordingly, the present invention has been made in view of the above-mentioned problems occurring in the prior art, and it is an object of the present invention to provide a valve combined with a water hammer arrester that is capable of combining the water hammer arrester thereto, thereby removing an intermediate connection member, a connection pipe, a socket connection member of the water hammer arrester which are needed additionally in the conventional valve structure and avoiding the connection processes of the above parts and the welding process to save the personnel costs for the operations, so that it is disposed on a pipe to open and close a pipe passage, thereby performing its inherent function and the function of the water hammer arrester at the time when the valve is closed, wherein the functions are the same as those of a plurality of conventional parts through their multiple combination.

It is another object of the present invention to provide a valve combined with a water hammer arrester that is capable of removing a connection member for the water hammer arrester which causes the volume of the valve to be bulky, thereby avoiding the formation of the connection member to the water hammer arrester and the welding process therebetween and reducing the volume of the valve and the number of parts thereof.

To accomplish the above objects, according to the present invention, there is provided a valve combined with a water hammer arrester, the valve having a first connection port connected to an inlet side to control a passage in a pipe, a second connection port connected to other pipe at an outlet side, a pipe line formed between the first connection port and the second connection port, a shutoff part disposed in the pipe line to control a fluid flowing along the pipe line, and a drive part adapted to transmit a drive force to the shutoff part, the valve including the water hammer arrester having a cylindrical casing having one side closed and the other side open, a shock-absorbing material being put into the cylindrical casing, and a piston adapted to be inserted into the cylindrical casing, the piston having packing members mounted thereon to prevent the leakage of the shock-absorbing material, wherein the drive part of the valve has an insertion portion formed by reducing the lower portion of the water hammer arrester, so that the insertion portion of the water hammer arrester functions as a spindle of the valve and a body of the water hammer arrester functions as an operating handle of the valve.

### BRIEF DESCRIPTION OF THE SEVERAL VIEWS OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional valve with a water hammer arrester;

FIG. 2 is a sectional view showing a valve combined with a water hammer arrester according to a first embodiment of the present invention;

FIG. 3 is a sectional view showing a valve combined with a water hammer arrester according to a second embodiment of the present invention;

FIG. 4 is a sectional view showing a valve combined with a water hammer arrester according to a third embodiment of the present invention;

FIG. 5 is a sectional view showing a valve combined with a water hammer arrester according to a fourth embodiment of the present invention;

FIG. 6 is a partial sectional view showing the valve combined with a water hammer arrester according to a fifth embodiment of the present invention;

FIG. 7 is a partial sectional view showing the conventional valve; and

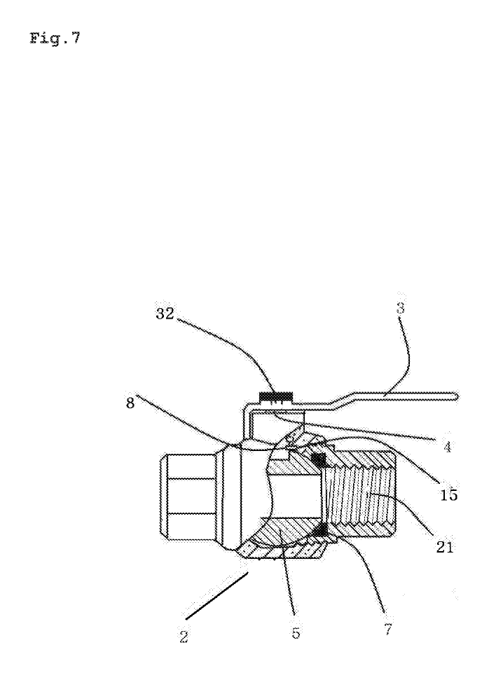

FIG. 8 is a perspective view showing the installation state of the conventional valve.

### DETAILED DESCRIPTION OF THE INVENTION

Hereinafter, an explanation on a valve combined with a water hammer arrester according to the preferred embodiments of the present invention will be in detail given with reference to the attached drawings.

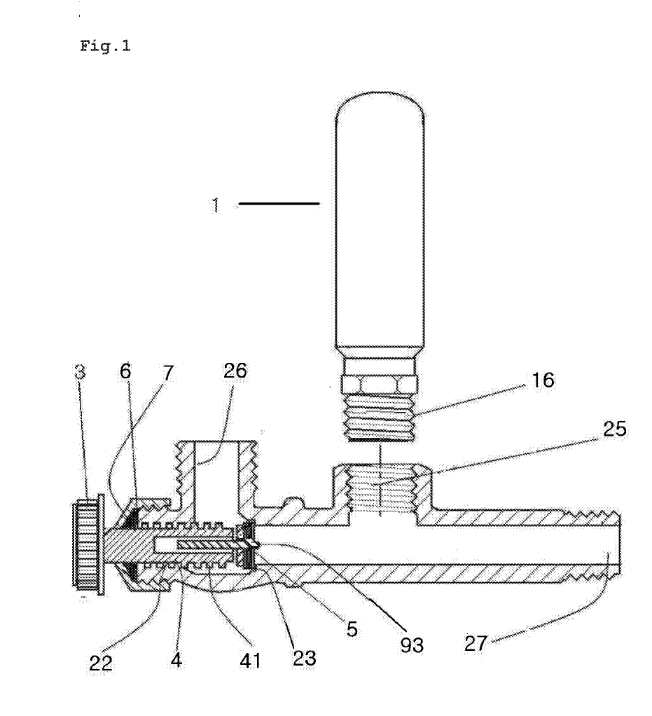

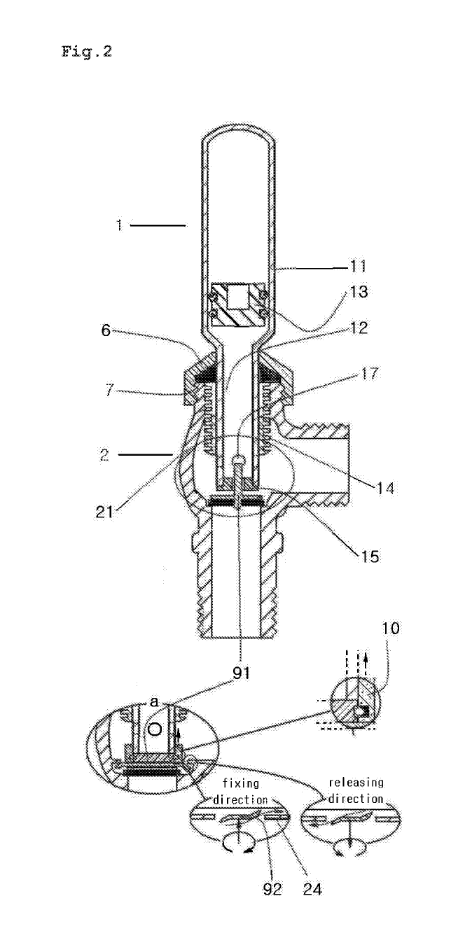

Referring to FIG. 2, unlike a conventional practice wherein a water hammer arrester as one unit component is separately mounted on a valve, a water hammer arrester 1 as one of main components constituting a valve 2 is integrally mounted to the valve 2, thereby having two inherent functions. That is, the lower portion of the water hammer arrester 1 is reduced in diameter to form an insertion portion 12, which serves as the conventional spindle 4 (as shown in FIG. 1) as a main component transmitting a drive force, and further, a body 11 of the water hammer arrester 1 serves as the conventional handle 3 (as shown in FIG. 1) causing the drive force of the spindle 4 thereby, so that the drive part of the valve is replaced with the water hammer arrester.

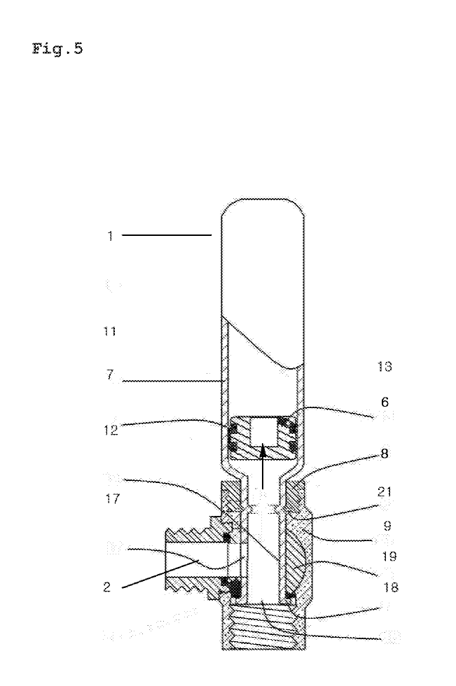

According to the first embodiment of the present invention wherein if the body 11 of the water hammer arrester 1 serves as the handle of the valve, it is easy to manipulate the valve 2, which solves the conventional problem wherein so as to reduce the whole volume of the valve and the manufacturing cost thereof, the size of the conventional handle becomes small, thereby making the manipulation of the handle actually hard. In view of economical benefits, further, the lower portion of the water hammer arrester 1 is reduced to form the insertion portion 12 into which a given connection member is inserted, so that through simple machining and change, the insertion portion 12 can be replaced with the spindle of the conventional valve. Moreover, a fluid inlet port 18 (see FIG. 5) formed as a passage of a fluid on the lower end of the water hammer arrester 1 is utilized as a space into which a stem 93 of a conventional shutoff part 5 as shown in FIG. 1 is inserted, and in this case, if the size of the space is too large, insertion members 15 having different diameter are adopted thereinto.

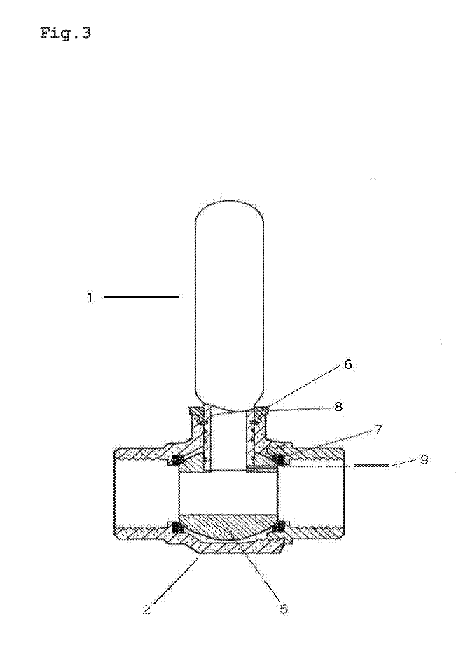

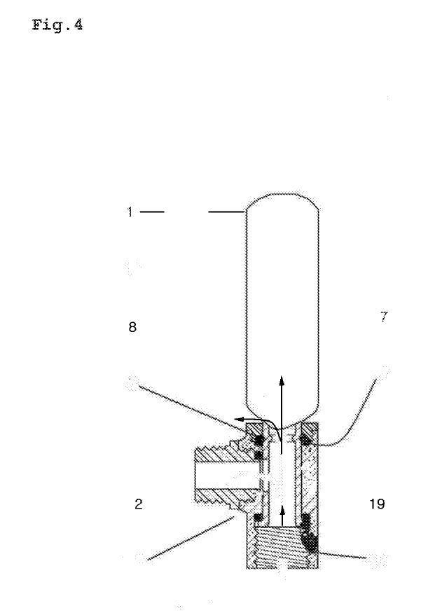

The spindle of the valve is rotated by means of the rotation of the handle, and by the way, as shown in FIGS. 3 and 4, if a ball or a side fluid passage as the conventional shutoff part 5 is coupled to the end of the spindle 4 or is formed thereon, the passage is open and closed by means of the rotating motion. As shown in FIG. 2, if a male screw is coupled to the spindle 4, the male screw is operated cooperatively with a female screw formed on the body 21 of the valve correspondingly thereto, so that so as to close the passage by means of the linear movement caused by the rotation of the spindle 4, the shutoff part is generally configured to allow a packing attached on a flat disc type packing support 91 to push into a shutoff groove 23 (as shown in FIG. 1) formed on the inner periphery of the passage of the body 21 of the valve.

According to the second embodiment of the present invention, as shown in FIG. 3, the shutoff part 5 of the ball valve is configured in a simple manner to have a ball embedded into the body 21 of the valve and a packing inserted into a gap between the body 21 and the ball. Accordingly, the insertion portion 12 of the water hammer arrester 1 is coupled with the ball as the shutoff part, and so as to transmit a driving force to them, the insertion portion 12 and a fixing groove formed on the ball are welded or fixed to each other by means of fixing pins or screws 9. Alternatively, the insertion portion 12 of the water hammer arrester 1 and the fixing groove of the ball are coupled polygonally to each other. So as to prevent the body 21 of the valve and the insertion portion 12 of the water hammer arrester 1 from being escaped from each other or to prevent water between them from leaking to the outside, further, the shutoff part of the ball valve includes a packing, a fixing ring 8 adapted to be inserted into a fixing groove formed on the outer peripheral surface of the insertion portion 12, and an end cap 6 mounted on the body 21 of the valve, which have the same structure as the known valve structure.

As shown in FIG. 2, since the shutoff part of the angle valve shuts off the linear movement, it may have an integral type shutoff part (a) connected directly to the lower end of the insertion portion 12 of the water hammer arrester 1 and a separate moving type shutoff part wherein a stem is inserted into the fluid inlet port of the lower end of the water hammer arrester. In case of the separate moving type shutoff part, especially, if there is a large difference between the inside diameter of the tube of the lower end fluid inlet port and the outer diameter of the insertion shaft inserted into the fluid inlet port, the insertion members 15 having different diameter are mounted to reduce the gap between them, so that in every case, the shutoff part can control the opening/closing of the valve by means of the driving force transmitted by the rotation function of the water hammer arrester 1.

The installation of the shutoff part should have a structure capable of allowing the water hammer arrester 1 to perform its inherent functions. In case of the ball valve, the passage in the ball is not formed in a conventional linear shape, but a triangular passage is formed in a shape of “⊥” or “┤”. In this case, the passage moving upwardly permits the fluid to freely flow along the fluid inlet port of the lower portion of the water hammer arrester 1 serving as the spindle, and even if the shutoff part for the linear movement on the angle valve shuts off the fluid inlet port of the lower portion of the water hammer arrester 1, the introduced water forming water hammer should flow in and out. Accordingly, one or more fluid passages are formed in a lateral direction at appropriate positions of the pipe forming the spindle of the water hammer arrester 1, and alternatively, the insertion members having different diameter mounted on the shaft of the separate moving type shutoff part are used with an auxiliary member such as a net member or a porous member.

More particularly, if a side fluid inlet port 17 (as shown in FIG. 5) is formed on an appropriate position of the side portion of the insertion portion 12 forming the spindle of the water hammer arrester 1, the passage connected with the fluid inlet port of the insertion portion 12 has the same function as the passage of the ball of the ball valve. The fourth embodiment of the present invention has the passage in a shape of “⊥” or “┤” like the ball or a large number of passages than the ball. Instead of the ball as an opening/closing part of the body of the valve, the insertion portion 12, which serves as the opening/closing member of the valve formed as the side fluid passage, becomes the opening/closing part of the body of the valve. Accordingly, there is no large difference between the basic structures in coupling of the invention and the conventional practice, and the installation of other additional members in the invention is almost the same as the conventional practice. That is, a packing is disposed on a leaking portion, and so as to prevent the water hammer arrester 1 from being escaped from the valve, a fixing part like a fixing ring or an escape prevention protrusion 19 formed outwardly in a round shape may be formed.

According to the present invention, there is provided a structure wherein if the shutoff part is rotated forwardly, it is fastened, and if rotated backwardly, it is unfastened, so that the spindle and the shutoff part are coupled to each other or separated from each other in the state of closing the fluid therebetween, thereby performing the assembling on site and the exchange while in use. Referring to FIG. 2, a fixing protrusion 24 having equally spaced protruded portions is formed inwardly along the inner periphery of the body of the valve, and if the shutoff part is rotated to reach the shutoff groove 23, fixing wings 92 formed on the periphery of the shutoff part in such a manner as to have both ends having different angles from each other are rotated forwardly. As a result, the fixing wings 92 are inserted into the fixing protrusion 24 (in the fixing direction as shown in FIG. 2), and if they are rotated backwardly, they are escaped from the fixing protrusion 24 (in the releasing direction as shown in FIG. 2). This structure may be applied to any one of the fixing protrusion 24 or the fixing wings 92 or to all of them. Further, the shutoff part and the spindle are detachably coupled to each other with ease in the state where the passage shuts off by means of the shutoff part. That is, if the valve is open in the state where the passage between the shutoff part and the spindle completely shuts off, since the rotary force of the spindle needs the rotary movement of the shutoff part and the process where the rotary force of the spindle is changed into the linear movement of the shutoff part does not need the solid coupling structure, the polygonal structures are formed on the spindle and the shutoff part for the transmission of rotation, and a groove is formed on a pipe having the same polygonal structure. Next, a detachable member 10, which has an elastic body like a spring or packing and a ball bearing inserted into the elastic body, is inserted into the groove, and accordingly, the coupling between the spindle and the shutoff part is performed and the releasing of the coupling is also done. Alternatively, the detachable operation can be achieved manually or by using tools. The exchange operation may be performed through a water supply connection hole, and if there are limitations in the positions and spaces, the exchange operation may be achieved through the formation of a separate repair hole.

FIG. 5 shows the valve combined with a water hammer arrester according to the fourth embodiment of the present invention. Generally, the valve largely includes the body 21, the handle 3 adapted to operate the valve, the drive part having the spindle 4 connected to the opening/closing part to transmit the drive force of the handle 3 to the opening/closing part, the opening/closing part, and additional parts or structure like the packing or fixing ring. According to the present invention, in this case, the handle 3, the spindle 4 and the opening/closing part of the valve are replaced with the water hammer arrester 1. That is, the handle 3 is replaced with the body 11 of the water hammer arrester 1, and the spindle 4 transmitting the drive force of the handle 3 is replace with the insertion portion 12 formed on the reduced lower portion of the water hammer arrester 1, so that the body 11 and the insertion portion 12 of the water hammer arrester 1 serve as the drive part that opens and closes the valve. Furthermore, if a hole is formed on the side of the insertion portion 12 as the side fluid passage 17 through which the fluid is passed, the side fluid passage 17 serves as an opening/closing port that opens and closes the passage of the valve by means of the drive part, together with the fluid inlet portion 18 of the water hammer arrester 1 and the passage of the body of the valve.

On the other hand, if the side fluid passage 17 is formed horizontally on both sides of the insertion portion 12 and the horizontal passage is formed on both sides of the body of the valve, a linear valve capable of being connected linearly to an external pipe can be provided. Also, if the passage of the body of the valve is formed in the longitudinal direction of the body 11 of the water hammer arrester 1, the passage and the fluid inlet port 18 of the water hammer arrester 1 are open to each other, thereby providing the valve connected to the external pipe to the shape of “•” or “⊥”.

Like this, the valve provided by coupling the body 21 and the water hammer arrester 1 has a packing 7 adapted to prevent the leaking between the body 21 and the water hammer arrester 1, and so as to prevent the water hammer arrester 1 from being escaped from the body 21 of the valve, further, the fixing ring 8 is inserted into the fixing groove 15 formed on the outer peripheral surface of the insertion portion 12. So as to improve the vertical stability of the insertion portion 12 and to provide the locking function in the coupling of the valve, further, the end cap 6 is mounted on the body 21 of the valve, and so as to prevent the water hammer arrester 1 from being escaped from the valve, the escape prevention protrusion 19 is formed outwardly in a round shape along the lower periphery of the insertion portion 12 is such a manner as to correspond with the round protruding surface of the inner periphery of the body 21 of the valve.

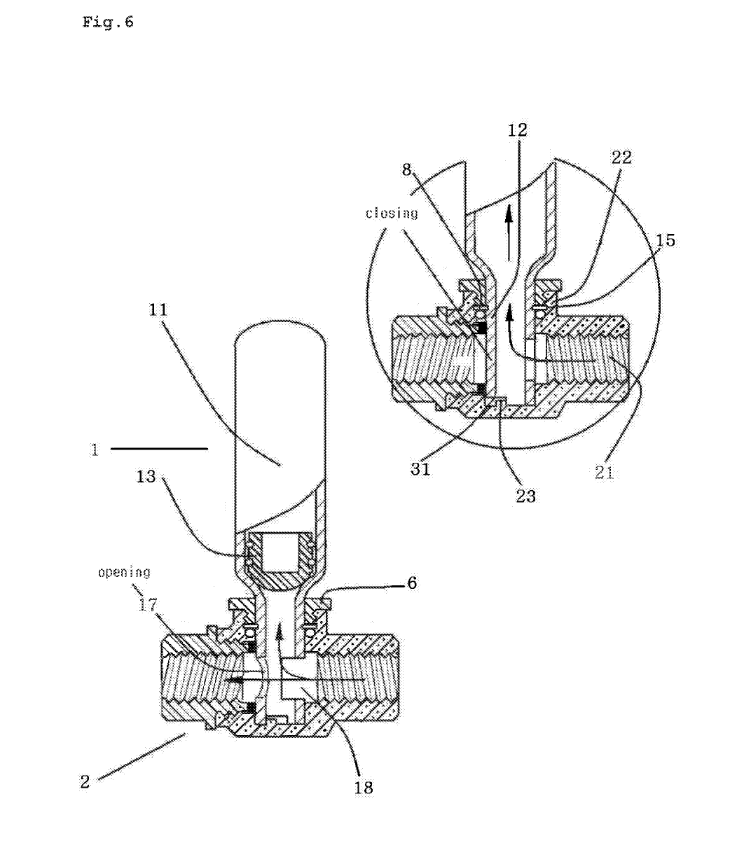

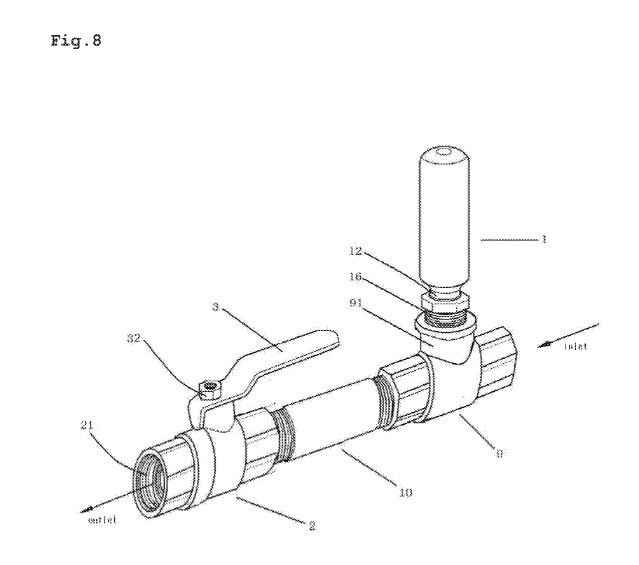

FIG. 6 shows a valve combined with a water hammer arrester according to a fifth embodiment of the present invention. A shock-absorbing material is put into a cylindrical casing and a piston 13 is inserted into the cylindrical casing, while having packing members 7 like O-rings adapted to prevent the shock-absorbing material from leaking. The lower portion of the body 11 of the water hammer arrester 1 is reduced to prevent the piston 13 from being escaped from the water hammer arrester 1. At the same time, the insertion portion 12 is inserted into a socket connection port 16 as shown in FIG. 8 wherein the conventional installation structure of the valve is illustrated and then welded to each other, thereby completing the installation of the water hammer arrester 1. Accordingly, the socket connection port 16 welded to the water hammer arrester 1 is coupled to a branch pipe of an intermediate connection member.

In the conventional practice, the water hammer arrester is coupled to the ball valve by means of the intermediate connection member, but in the structure of the water hammer arrester 1 according to the present invention, the handle, the spindle, the opening/closing part formed of the ball, and the operating stopper 31 are replaced with the water hammer arrester 1.

That is, the handle of the ball valve is replaced with the body 11 of the water hammer arrester 1, and the insertion portion 11 formed by reducing the lower portion of the water hammer arrester 1 is replaced with the spindle 4 transmitting the drive force of the handle of the ball valve. Further, the passage of the ball functioning as the opening/closing function of the conventional ball valve is replaced with holes formed on the side of the insertion portion 12 of the water hammer arrester 1, and especially, the hole formed at the position corresponding to the outlet side passage on both pipes of the horizontal passage of the body of the valve becomes an opening/closing hole 17 functioning to open and close the valve. A packing 7 is disposed between the opening/closing hole 17 and the horizontal passage of the body of the valve, thereby preventing leaking therebetween. On the other hand, an inlet hole 18 is formed on the opposite side to the opening/closing hole 17, which is open at the time when the opening/closing hole 17 is open and closed. The inlet hole 18 may be formed on the side of the insertion portion 12 to a large size capable of forming the passage, formed long in the transverse direction, or formed of a plurality of holes. Alternatively, irrespective of the shape of the insertion portion 12, the inlet port 18 may be formed in the lateral and lower space of the body of the valve where the passage is formed. Accordingly, the hole formed on the insertion portion 12 of the water hammer arrester 1 is formed on the outlet side passage of the valve, which becomes the opening/closing hole 17 functioning to open and close the valve, and the inlet hole 18 is open even if the valve is closed. Therefore, if the opening/closing passage of the valve is formed by means of the outlet hole and the inlet hole formed on both sides of the insertion portion of the water hammer arrester like the ball as the opening/closing part of the conventional ball valve, the two holes have the same functions as each other in opening/closing the valve, so that at the time when the valve is closed, the inlet hole through which the water hammer passage is formed in the water hammer arrester is accordingly closed, thereby losing the function absorbing the water hammer to cause the inherent function of the water hammer arrester to disappear.

At the time when the body 21 of the valve and the insertion portion 12 of the water hammer arrester 1 are coupled to each other, the packing 7 is disposed therebetween to prevent leakage between the opening/closing hole of the water hammer arrester 1 formed on the side of the body 21 of the valve and the horizontal passage of the outlet hole side of the valve. Further, a packing like an O-ring is disposed between a branch pipe 22 of the body 21 of the valve and the insertion portion 12 of the water hammer arrester 1 so as to prevent the leakage therebetween, and a groove is formed along the insertion portion 12 of the water hammer arrester 1. Alternatively, the fixing ring groove 15 is formed by reducing the water hammer arrester 1 in diameter, and the fixing ring 8 is inserted into the fixing ring groove 15. Additionally, the end cap 6 into which the spindle is inserted is screw-coupled to the end of the branch pipe 22 of the body 21 of the valve, thereby enhancing the sealing force of the packing and preventing the insertion portion 12 of the water hammer arrester 1 coupled to the fixing ring 8 from being escaped vertically from the valve.

According to the valve combined with the water hammer arrester 1, the body of the water hammer arrester 1 serves as the operating handle, and if the body is rotated, the insertion portion 12 serves as the spindle, thereby opening and closing the outlet hole. Even when the opening/closing hole is closed, the water hammer transmitted to the inlet hole 18 always open can be absorbed to the water hammer arrester 1 serving as the operating handle.

On the other hand, a control groove 31 is formed on the lower end of the insertion portion 12 by the width of the angle through which the body 11 of the water hammer arrester 1 functioning as the operating handle is rotated to be open and closed, and a stopper 23 is protrudedly formed on the lower portion of the body of the valve to stop the control groove 31, so that the body 11 of the water hammer arrester 1 functioning as the operating handle stops at the opening/closing positions. In this case, the valve should be disposed to correspond to the directions into/from which the fluid flows, thereby operating the water hammer arrester 1, and accordingly, words “front” and “back” or “inlet port” or arrows may be indicated on given positions of the outer periphery of the valve to prevent the mistakes in the installation of the valve.

As set forth in the foregoing, the valve combined with the water hammer arrester according to the present invention can remove the intermediate connection member and the parts of the connection pipe to reduce the manufacturing materials, the labor charges and the construction period, remove the handle, drive shaft and ball from the valve and the socket connection member and welding processes for connection from the water hammer arrester, and efficiently utilize a given space through the reduction of the space to be dead.

Moreover, the spindle and the drive handle as the important parts of the valve are replaced with the body and insertion portion of the water hammer arrester, and in this case, the functions of the water hammer arrester and the valve are inherently performed. In case of the angle valve, accordingly, it has the side fluid passage formed as a hole formed on the side of the insertion portion of the water hammer arrester, so that even though the opening/closing part shuts off the inlet port of the lower end of the water hammer arrester, the introduced water causing the water hammer is transmitted to the body of the water hammer arrester and the piston in the inside of the water hammer arrester, and in case of the ball valve, contrarily, the passages in three directions are formed in a shape of “⊥” or “┤”, unlike the conventional practice wherein a linear passage is formed on the ball.

Further, the ball valve to which the vertically advancing passage is added may be connected directly to the fluid inlet port of the lower end of the water hammer arrester, and furthermore, the side fluid passage of the insertion portion of the water hammer arrester may be utilized as the passage of the ball, thereby fully maintaining the inherent functions of the valve and the water hammer arrester.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A valve combined with a water hammer arrester, the valve having a first connection port connected to an inlet side to control a passage in a pipe, a second connection port connected to other pipe at an outlet side, a pipe line formed between the first connection port and the second connection port, a shutoff part disposed in the pipe line to control a fluid flowing along the pipe line, and a drive part adapted to transmit a drive force to the shutoff part, comprising the water hammer arrester having a cylindrical casing having one side closed and the other side open, a shock-absorbing material being put into the cylindrical casing, and a piston adapted to be inserted into the cylindrical casing, the piston having packing members mounted thereon to prevent the leakage of the shock-absorbing material, wherein the drive part of the valve has an insertion portion formed by reducing the lower portion of the water hammer arrester, so that the insertion portion of the water hammer arrester functions as a spindle of the valve and a body of the water hammer arrester functions as an operating handle of the valve.

2. The valve combined with a water hammer arrester according to claim 1, wherein the insertion portion of the water hammer arrester comprises a side fluid inlet port formed as a hole for a fluid passage on the side thereof and a drive male screw formed along the outer periphery thereof to receive an external rotary force and to convert the rotary force into a linear motion, so that the insertion portion functions as the spindle of the valve, and the body of the valve comprises a drive female screw formed along the inner periphery of the pipe line to correspond to the drive male screw formed on the insertion portion of the water hammer arrester.

3. The valve combined with a water hammer arrester according to claim 1, wherein the insertion portion of the water hammer arrester is coupled to one of the fluid passages connected to one another in three directions in a ball as the shutoff part of a ball valve.

4. The valve combined with a water hammer arrester according to claim 1, wherein the insertion portion of the water hammer arrester comprises a hole formed as an opening/closing port on the side thereof in such a manner as to be open and closed in accordance with the operation of the valve and a fluid inlet port formed as an opening passage in the interior thereof, so that the insertion portion is mounted in the interior of the valve and functions as the opening/closing part of the valve.

5. The valve combined with a water hammer arrester according to claim 4, wherein the insertion portion of the water hammer arrester is coupled to the ball forming a passage corresponding to the side fluid passage of the water hammer arrester.

6. A valve combined with a water hammer arrester, comprising:
the water hammer arrester having an insertion portion formed by reducing the lower portion thereof in diameter in such a manner as to be inserted into a body of the valve in which pipe lines are formed in two or more directions in a state where an opening/closing part is formed in the middle of the pipe line of the body of the valve, thereby functioning as a spindle of the valve and a body functioning as a drive handle of the valve;
a packing member disposed between the insertion portion of the water hammer arrester and the inner periphery of the body of the valve;
a fixing ring member mounted along a round fixing groove formed on the outer periphery of the insertion portion; and
an end cap coupled to the end periphery of the pipe line of the body of the valve to compress the fixing ring member and the packing member,
wherein the insertion portion has holes for passage formed on the side thereof in such a manner as to correspond linearly to both pipe lines of the valve, the holes being formed to correspond to the outlet side pipe line of both pipe lines of the valve at the time when the valve is open, and a control groove formed on the lower end of the insertion portion by a given width through which the valve is open and closed, and the valve has the opening/closing part as an opening/closing hole formed between the body of the valve and a packing member to allow the valve to be open and closed and a stopper protrudedly formed on the body of the valve within the control groove,
whereby one of the holes of the insertion portion functions as an opening/closing hole that open and closes the passage, the other hole forming an inlet hole always open irrespective of the opening and closing of the opening/closing hole, and the body of the valve further having arrows indicated on the outer periphery thereof to guide the order of installation of inlet pipe and outlet pipe.

7. The valve combined with a water hammer arrester according to claim 6, wherein the insertion portion comprises an inlet hole formed thereon, the inlet hole having width and size openable to correspond to the opening/closing operation range of the opening/closing hole.

8. The valve combined with a water hammer arrester according to claim 6, wherein the body of the valve on which the inlet hole is located has a pipe line forming a passage thereon at the time when the opening/closing hole is closed.
